(19) United States
(12) Patent Application Publication
(10) Pub. No.: US 2023/0061073 A1
(43) Pub. Date: Mar. 2, 2023

(54) TIMING MANAGEMENT FOR INTER-USER EQUIPMENT COORDINATION

(71) Applicant: QUALCOMM Incorporated, San Diego, CA (US)

(72) Inventors: Sourjya Dutta, San Diego, CA (US); Tien Viet Nguyen, Bridgewater, NJ (US); Gabi Sarkis, San Diego, CA (US); Seyedkianoush Hosseini, San Diego, CA (US); Shuanshuan Wu, San Diego, CA (US); Kapil Gulati, Belle Mead, NJ (US); Gene Wesley Marsh, San Diego, CA (US); Shailesh Patil, San Diego, CA (US)

(21) Appl. No.: 17/899,339

(22) Filed: Aug. 30, 2022

Related U.S. Application Data
(60) Provisional application No. 63/239,739, filed on Sep. 1, 2021.

(51) Int. Cl. H04W 72/02; H04W 72/04; H04W 76/28; H04W 72/12

(52) U.S. Cl. CPC H04W 72/02; H04W 72/0406; H04W 76/28; H04W 72/1247

(57) ABSTRACT

Methods, systems, and devices for wireless communications are described. Generally, the described techniques provide for managing timing for inter-user equipment (UE) coordination to prevent or minimize interference or collisions between sidelink transmissions. A first UE may determine a time window in which to select sidelink resources for an inter-UE coordination message based on a minimum time configured for selecting the sidelink resources. The minimum time configured for selecting the sidelink resources for the inter-UE coordination message may be different from a minimum time configured for selecting sidelink resources for other sidelink messages. The first UE may then select the sidelink resources in the time window for the inter-UE coordination message and transmit the inter-UE coordination message on the selected sidelink resources to the second UE over a sidelink.

### CROSS REFERENCE

The present application for patent claims the benefit of U.S. Provisional Patent Application No. 63/239,739 by DUTTA et al., entitled “TIMING MANAGEMENT FOR INTER-USER EQUIPMENT COORDINATION,” filed Sep. 1, 2021, assigned to the assignee hereof, and expressly incorporated by reference herein.

### FIELD OF TECHNOLOGY

The following relates to wireless communications, including timing management for inter-user equipment coordination.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations or one or more network access nodes, each simultaneously supporting communication for multiple communication devices, which may be otherwise known as user equipment (UE). Some wireless communications systems may support sidelink communications between UEs. In such systems, it may be appropriate for UEs to exchange messages to coordinate communications on sidelink resources (e.g., to avoid interference and collisions). Such messages may be referred to as inter-UE coordination messages. Improved techniques for utilizing inter-UE coordination messages may be desirable.

### SUMMARY

The described techniques relate to improved methods, systems, devices, and apparatuses that support timing management for inter-user equipment (UE) coordination. Generally, the described techniques provide for managing timing for inter-UE coordination to prevent or minimize interference or collisions between sidelink transmissions. A first UE may determine a time window in which to select sidelink resources for an inter-UE coordination message based on a minimum time configured for selecting the sidelink resources. The minimum time configured for selecting the sidelink resources for the inter-UE coordination message may be different from a minimum time configured for selecting sidelink resources for other sidelink messages. The first UE may then select the sidelink resources in the time window for the inter-UE coordination message and transmit the inter-UE coordination message on the selected sidelink resources to a second UE over a sidelink.

A method for wireless communication at a first UE is described. The method may include determining a time window in which to select sidelink resources for an inter-UE coordination message based on a minimum time configured for selecting the sidelink resources for the inter-UE coordination message, where the minimum time configured for selecting the sidelink resources for the inter-UE coordination message is different from a minimum time configured for selecting sidelink resources for other sidelink messages, selecting the sidelink resources in the time window for the inter-UE coordination message based on the determining, and transmitting the inter-UE coordination message on the selected sidelink resources to a second UE over a sidelink.

An apparatus for wireless communication at a first UE is described. The apparatus may include a processor, memory coupled to the processor, the memory including instructions executable by the processor to cause the apparatus to determine a time window in which to select sidelink resources for an inter-UE coordination message based on a minimum time configured for selecting the sidelink resources for the inter-UE coordination message, where the minimum time configured for selecting the sidelink resources for the inter-UE coordination message is different from a minimum time configured for selecting sidelink resources for other sidelink messages, select the sidelink resources in the time window for the inter-UE coordination message based on the determining, and transmit the inter-UE coordination message on the selected sidelink resources to a second UE over a sidelink.

Another apparatus for wireless communication at a first UE is described. The apparatus may include means for determining a time window in which to select sidelink resources for an inter-UE coordination message based on a minimum time configured for selecting the sidelink resources for the inter-UE coordination message, where the minimum time configured for selecting the sidelink resources for the inter-UE coordination message is different from a minimum time configured for selecting sidelink resources for other sidelink messages, means for selecting the sidelink resources in the time window for the inter-UE coordination message based on the determining, and means for transmitting the inter-UE coordination message on the selected sidelink resources to a second UE over a sidelink.

A non-transitory computer-readable medium storing code for wireless communication at a first UE is described. The code may include instructions executable by a processor to determine a time window in which to select sidelink resources for an inter-UE coordination message based on a minimum time configured for selecting the sidelink resources for the inter-UE coordination message, where the minimum time configured for selecting the sidelink resources for the inter-UE coordination message is different from a minimum time configured for selecting sidelink resources for other sidelink messages, select the sidelink resources in the time window for the inter-UE coordination message based on the determining, and transmit the inter-UE coordination message on the selected sidelink resources to a second UE over a sidelink.

In some examples of the method, apparatuses, and non-transitory computer-readable medium described herein, determining the time window may include operations, features, means, or instructions for determining that a duration of the time window may be equal to the minimum time configured for selecting the sidelink resources for the inter-UE coordination message. In some examples of the method, apparatuses, and non-transitory computer-readable medium described herein, determining the time window may include operations, features, means, or instructions for determining that a duration of the time window may be between the minimum time configured for selecting the sidelink resources for the inter-UE coordination message and a maximum time configured for selecting the sidelink resources for the inter-UE coordination message, where the maximum time may be equal to a delay budget for the inter-UE coordination message.

In some examples of the method, apparatuses, and non-transitory computer-readable medium described herein, the delay budget for the inter-UE coordination message may be based on a quality of service requirement associated with the inter-UE coordination message, a maximum delay indicated in an upper-layer configuration for the inter-UE coordination message, contents of the inter-UE coordination message, or a combination thereof. In some examples of the method, apparatuses, and non-transitory computer-readable medium described herein, the inter-UE coordination message indicates one or more sets of resources reserved by one or more other UEs for sidelink communications, and the maximum delay for the inter-UE coordination message may be based at least in part on a time at which each of the one or more sets of resources may be reserved.

In some examples of the method, apparatuses, and non-transitory computer-readable medium described herein, determining the time window may include operations, features, means, or instructions for selecting an initial time window in which to select the sidelink resources for the inter-UE coordination message based on the minimum time configured for selecting the sidelink resources and expanding the initial time window until a threshold quantity of resources may be selected or until a duration of the expanded time window may be equal to a maximum time configured for selecting the sidelink resources for the inter-UE coordination message. In some examples of the method, apparatuses, and non-transitory computer-readable medium described herein, selecting the sidelink resources may include operations, features, means, or instructions for selecting the sidelink resources in the initial time window or the expanded time window based on a fixed resource selection threshold.

Some examples of the method, apparatuses, and non-transitory computer-readable medium described herein may further include operations, features, means, or instructions for identifying a priority value associated with the inter-UE coordination message and determining the minimum time configured for selecting the sidelink resources based on the identified priority value. In some examples of the method, apparatuses, and non-transitory computer-readable medium described herein, identifying the priority value associated with the inter-UE coordination message may include operations, features, means, or instructions for determining a maximum priority value of one or more sets of resources reserved by other UEs indicated in the inter-UE coordination message and identifying the priority value associated with the inter-UE coordination message to be equal to the determined maximum priority value.

In some examples of the method, apparatuses, and non-transitory computer-readable medium described herein, selecting the sidelink resources in the time window may include operations, features, means, or instructions for identifying a discontinuous reception cycle of the second UE and selecting the sidelink resources in the time window based on the discontinuous reception cycle of the second UE. In some examples of the method, apparatuses, and non-transitory computer-readable medium described herein, selecting the sidelink resources based on the discontinuous reception cycle of the second UE may include operations, features, means, or instructions for selecting the sidelink resources from one or more sections of the time window that overlap with an on-duration of the discontinuous reception cycle of the second UE.

In some examples of the method, apparatuses, and non-transitory computer-readable medium described herein, the on-duration of the discontinuous reception cycle of the second UE includes a first on-duration of a first discontinuous reception cycle of the second UE and the method, apparatuses, and non-transitory computer-readable medium may include further operations, features, means, or instructions for determining that the first on-duration of the first discontinuous reception cycle of the second UE fails to overlap with a second on-duration of a second discontinuous reception cycle of a third UE, where selecting the sidelink resources includes and selecting the sidelink resources for transmitting the inter-UE coordination message to the second UE based on the first on-duration of the second UE overlapping with an earlier set of resources in the time window than the second on-duration of the third UE.

Some examples of the method, apparatuses, and non-transitory computer-readable medium described herein may further include operations, features, means, or instructions for transmitting a subsequent inter-UE coordination message to the third UE, the subsequent inter-UE coordination message including the same or different contents from the inter-UE coordination message transmitted to the second UE. In some examples of the method, apparatuses, and non-transitory computer-readable medium described herein, selecting the sidelink resources may include operations, features, means, or instructions for selecting the sidelink resources from the one or more sections of the time window that overlap with the on-duration of the discontinuous reception cycle of the second UE based on iteratively adjusting a resource selection threshold.

Some examples of the method, apparatuses, and non-transitory computer-readable medium described herein may further include operations, features, means, or instructions for selecting an initial time window for selecting the sidelink resources for the inter-UE coordination message based on the minimum time configured for selecting the sidelink resources and expanding the initial time window and the one or more sections of the time window that overlap with the on-duration of the discontinuous reception cycle of the second UE until a threshold quantity of resources may be selected or until a duration of the expanded time window may be equal to a maximum time configured for selecting the sidelink resources. In some examples of the method, apparatuses, and non-transitory computer-readable medium described herein, selecting the sidelink resources may include operations, features, means, or instructions for selecting the sidelink resources in the initial time window or the expanded time window based on a fixed resource selection threshold.

In some examples of the method, apparatuses, and non-transitory computer-readable medium described herein, the sidelink resources selected for the inter-UE coordination message may be selected from a subset of available sidelink resources, and the subset of available sidelink resources may be allocated for transmitting inter-UE coordination messages. Some examples of the method, apparatuses, and non-transitory computer-readable medium described herein may further include operations, features, means, or instructions for receiving, at a lower layer from an upper layer, an indication of the minimum time configured for selecting the sidelink resources for the inter-UE coordination message.

### BRIEF DESCRIPTION OF THE DRAWINGS

FIG. 1 illustrates an example of a wireless communications system that supports timing management for inter-user equipment (UE) coordination in accordance with aspects of the present disclosure.

FIG. 2 illustrates an example of sidelink communications using mode-2 resource allocation in accordance with aspects of the present disclosure.

FIG. 3 illustrates an example of inter-UE coordination in accordance with aspects of the present disclosure.

FIG. 4 illustrates an example of a packet processing timeline for inter-UE coordination in accordance with aspects of the present disclosure.

FIG. 5 illustrates an example of a wireless communications system that supports timing management for inter-UE coordination in accordance with aspects of the present disclosure.

FIG. 6-8 illustrate examples of timing configurations for inter-UE coordination messages with discontinuous reception (DRX) in accordance with aspects of the present disclosure.

FIG. 9 illustrates an example of a process flow that supports timing management for inter-UE coordination in accordance with aspects of the present disclosure.

FIGS. 10 and 11 show block diagrams of devices that support timing management for inter-UE coordination in accordance with aspects of the present disclosure.

FIG. 12 shows a block diagram of a communications manager that supports timing management for inter-UE coordination in accordance with aspects of the present disclosure.

FIG. 13 shows a diagram of a system including a device that supports timing management for inter-UE coordination in accordance with aspects of the present disclosure.

FIG. 14 shows a flowchart illustrating methods that support timing management for inter-UE coordination in accordance with aspects of the present disclosure.

### DETAILED DESCRIPTION

Some wireless communications systems may support sidelink communications between user equipment (UEs). In such systems, it may be appropriate for UEs to exchange messages to coordinate communications on sidelink resources (e.g., to avoid interference and collisions). Such messages may be referred to as inter-UE coordination messages. In one example, if a first UE detects a conflict between a second UE and a third UE, the first UE may transmit an inter-UE coordination message to the second UE and the third UE indicating the conflict. In another example, if a first UE receives sidelink control information (SCI) from one or more other UEs (e.g., a third UE, a fourth UE, etc.) indicating resources reserved by the other UEs, the first UE may transmit (e.g., based on an aggregation of reservation information received from the other UEs) an inter-UE coordination message to a second UE (e.g., a resource information forwarding message) indicating the resources reserved by the other UEs or indicating resources over which the second UE may transmit (e.g., preferred resources). Although inter-UE coordination messages may help to coordinate sidelink communications in a system, it may be challenging to manage the timing of these messages.

As an example, if an inter-UE coordination message indicates resources reserved by a third UE or indicates an upcoming conflict between a second UE and a third UE, and a first UE transmits the inter-UE coordination message to the second UE long after identifying the resources reserved by the third UE or after the conflict between the second UE and the third UE, the information in the inter-UE coordination message may be out of date or stale by the time it is received by the second UE. For instance, a collision may still occur (e.g., between transmissions from the second UE and transmissions from the third UE) if the second UE receives the inter-UE coordination message from the first UE after the collision or a few slots before the collision (e.g., since the second UE may not have time to react to the inter-UE coordination message due to processing delays). However, if the first UE transmits the inter-UE coordination message to the second UE too early, the resources available for transmitting the inter-UE coordination message to the second UE may be limited, and the transmission of the inter-UE coordination message itself may interfere with other sidelink transmissions in a system.

As described herein, a wireless communications system may support efficient techniques for managing timing for inter-UE coordination to prevent or minimize interference or collisions between sidelink transmissions. A first UE may determine a time window in which to select sidelink resources for an inter-UE coordination message based on a minimum time configured for selecting the sidelink resources. The minimum time configured for selecting the sidelink resources for the inter-UE coordination message may be different from a minimum time configured for selecting sidelink resources for other sidelink messages. Accordingly, the time window in which to select the sidelink resources for the inter-UE coordination message may be adapted to allow a second UE to receive the inter-UE coordination message early enough to prevent interference and collisions but not too early such that the inter-UE coordination message interferes or collides with other sidelink transmissions. The first UE may then select the sidelink resources in the time window for the inter-UE coordination message and transmit the inter-UE coordination message on the selected sidelink resources to the second UE over a sidelink.

Aspects of the disclosure are initially described in the context of wireless communications systems. Examples of processes and signaling exchanges that support timing management for inter-UE coordination are then described. Aspects of the disclosure are further illustrated by and described with reference to apparatus diagrams, system diagrams, and flowcharts that relate to timing management for inter-UE coordination.

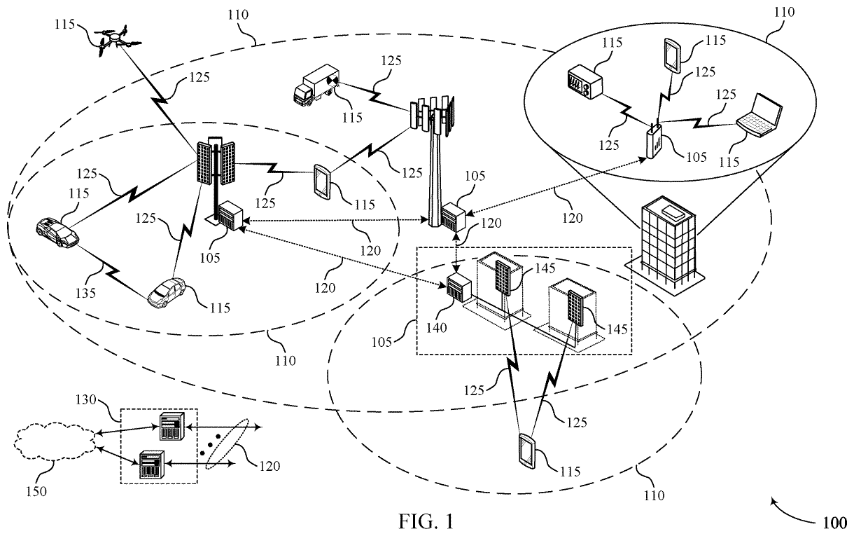

FIG. 1 illustrates an example of a wireless communications system 100 that supports timing management for inter-UE coordination in accordance with aspects of the present disclosure. The wireless communications system 100 may include one or more base stations 105, one or more UEs 115, and a core network 130. In some examples, the wireless communications system 100 may be a Long-Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105 (e.g., in a physical uplink control channel (PUCCH) or a physical uplink shared channel (PUSCH)), or downlink transmissions from a base station 105 to a UE 115 (e.g., in a physical downlink control channel (PDCCH) or a physical downlink shared channel (PDSCH)). Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105). In some examples, a base station 105 may refer to one or more network entities.

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

As mentioned above, UEs 115 may communicate with each other over a D2D communication link 135. The D2D communication link 135 may be referred to as a sidelink. In some cases, sidelink communications may include communications over one or more sidelink channels. For instance, sidelink data transmissions may be over a physical sidelink shared channel (PSSCH), sidelink discovery expression transmissions may be over a physical sidelink discovery channel (PSDCH) (e.g., to allow proximal devices to discover each other's presence), sidelink control information transmissions may be over a physical sidelink control channel (PSCCH), sidelink feedback transmissions may be over a physical sidelink feedback channel (PSFCH), and sidelink broadcast transmissions may be over a physical sidelink broadcast channel (PSBCH). Sidelink communications may also include transmitting reference signals from one UE 115 to another UE 115.

Sidelink communications may take place in transmission or reception resource pools. A minimum resource allocation unit for sidelink communications may be a sub-channel in a frequency domain, and a resource allocation in a time domain for sidelink communications may be one slot. Some slots may not be available for sidelink, and some slots may contain feedback resources. In some cases, a sidelink transmission from one UE 115 to another UE 115 may be a transmission on sidelink resources that the other UE 115 may monitor for the sidelink transmission. In some aspects, an RRC configuration for sidelink communications may be preconfigured (e.g., preloaded on a UE 115) or signaled to a UE 115 (e.g., from a base station 105). In some examples, a base station 105 facilitates the scheduling of resources for sidelink communications (e.g., in a resource allocation mode 1). In other cases, sidelink communications may be carried out between the UEs 115 without the involvement of a base station 105 (e.g., in a resource allocation mode 2).

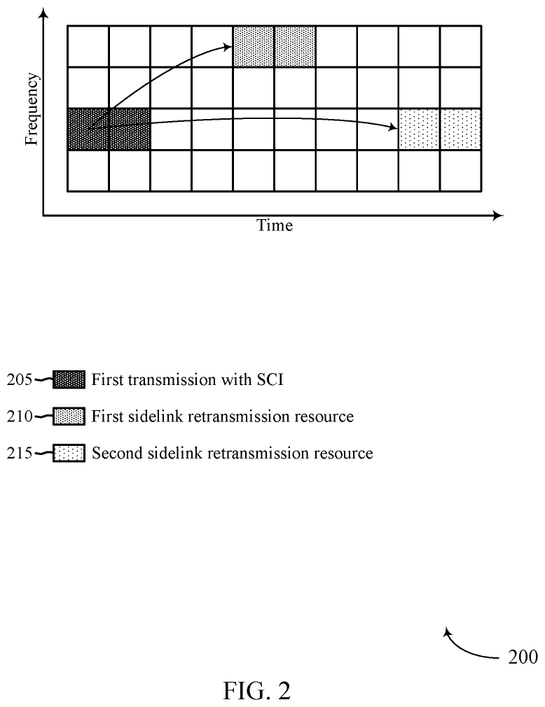

FIG. 2 illustrates an example of sidelink communications 200 using mode-2 resource selection in accordance with aspects of the present disclosure. In mode-2 resource selection, sidelink UEs 115 may autonomously reserve resources (e.g., without the involvement of a base station 105). That is, mode-2 may be supported without the presence of a central entity (e.g., such as a base station 105). After identifying resources to reserve for one or more sidelink transmissions, a UE 115 may transmit a first transmission of a data packet with an SCI 205 on sidelink resources. The SCI in 205 may indicate one or two future resources identified for subsequent retransmission (e.g., a first sidelink retransmission resource 210 and a second sidelink retransmission resource 215). In the example of FIG. 2, the UE 115 may then transmit a first retransmission of the data packet on the first sidelink retransmission resource 210 and a second retransmission of the data packet on the second sidelink retransmission resource 215.

A UE 115 may determine a set of candidate resources to use for sidelink communications and may continuously decode SCI from other UEs 115 (e.g., peers). The SCI from the other UEs 115 may include reservation information (e.g., resources such as slots or resource blocks that peers may use in the future), and the UE 115 may use the SCI to identify resources reserved by these other UEs 115. If the SCI from another UE 115 is received and decoded by the UE 115, and the UE 115 determines that the decoded SCI has a high reference signal received power (RSRP), the UE 115 may determine that the other UE 115 is possibly close to the UE 115 (e.g., resulting in higher interference). As such, the UE 115 may remove resources indicated in the decoded SCI from the set of candidate resources to use for sidelink communications. The UE 115 may then randomly select N resources from the set of candidate resources for transmitting or retransmitting a transport block. In some examples, for every transmission, the UE 115 may reserve resources for up to two retransmissions in the future.

In some cases, there may be one or more causes for a loss in reliability associated with sidelink transmissions. For instance, a first transmission from a UE 115 may be unprotected. Specifically, if the UE 115 does not reserve resources for the first transmission or other UEs 115 fail to receive a reservation of resources from the UE 115, the other UEs 115 may schedule transmissions that interfere with the first transmission from the UE 115 (e.g., the first transmission may collide with another transmission). In addition, the UE 115 may experience half-duplex loss if an intended receiver of a first transmission is scheduled to transmit another transmission and receive the first transmission at the same time (e.g., on the same time slot or TTI). In some examples, a transmitting UE 115 may also experience link quality issues with a receiving UE 115 (e.g., due to a non-line-of-sight (NLOS) component of a link with the receiving UE 115, a large distance between the transmitting UE 115 and the receiving UE 115, etc.).

To improve the quality of sidelink communications in wireless communications system 100 (e.g., to avoid interference and collisions), it may be appropriate for UEs 115 supporting sidelink communications to exchange messages to coordinate communications on sidelink resources. Such messages may be referred to as inter-UE coordination messages. In one example, a first UE 115 may send to a second UE 115 an inter-UE coordination message indicating a set of resources preferred or not preferred (e.g., non-preferred) for a transmission from the second UE 115 (e.g., based on a sensing result). In another example, the first UE 115 may send to the second UE 115 an inter-UE coordination message indicating a set of resources where a resource conflict is detected.

To facilitate inter-UE coordination, it may be appropriate to determine how or when the first UE 115 determines the contents of the indicated set of resources (e.g., including consideration of uplink scheduling). Further, it may be appropriate to determine one or more of the following: when a first UE 115 sends an indication of a set of resources to a second UE 115, which UEs 115 are to send indications of a set of resources, how the first UE 115 and the second UE 115 are determined, how the first UE 115 sends a set of resources to the second UE 115 (e.g., including a container for carrying the indication, implicitly, explicitly, or both), how, when, or whether the second UE 115 receives a set of resources and takes the set of resources into account in resource selection for a transmission from the second UE, and how or whether to define a relationship between support or signaling of inter-UE coordination and a cast type.

A UE 115 in wireless communications system 100 may support efficient techniques for utilizing inter-UE coordination messages.

In one example, a first UE 115 may use an inter-UE coordination message for conflict detection and indication. In this example, the first UE 115 may detect a conflict between a second UE 115 and a third UE 115, and the first UE 115 may transmit an inter-UE coordination message to the second UE 115 and the third UE 115 indicating the conflict. In some cases, the first UE 115 may transmit the indication of the conflict before the conflict event (e.g., pre-conflict) based on future reservation information (e.g., applicable for groupcast and unicast). In other cases, the first UE 115 may transmit the indication of the conflict after the conflict event (e.g., post-conflict) based on decoding the current transmissions in a conflict (e.g., for groupcast communications).

In another example, a first UE 115 may use an inter-UE coordination message for resource information forwarding. Such an inter-UE coordination message may be referred to as a resource information forwarding message. In this example, the first UE 115 may transmit an indication to a second UE 115 of one or a set of resources for the second UE 115 to use or avoid. For instance, the first UE 115 may forward reservation information sent by a third UE 115 to the second UE 115. Additionally, or alternatively, the first UE 115 may transmit resource information to the second UE 115 in a resource information forwarding message based on the reservation information sent by the third UE 115. In another instance, the first UE 115 may forward reservation information from the third UE 115 to the second UE 115 when the reservation information is requested by the second UE. Upon receiving the reservation information or resource information from the first UE 115, the second UE 115 may select an appropriate resource that does not create a conflict with the third UE 115.

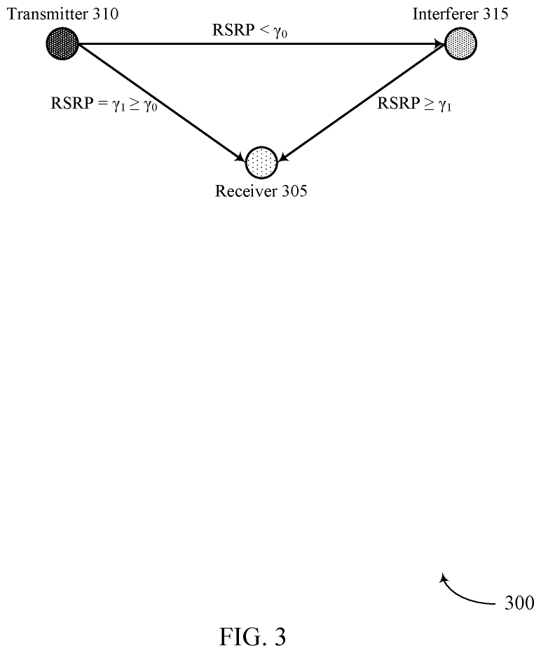

FIG. 3 illustrates an example of inter-UE coordination 300 in accordance with aspects of the present disclosure. In one example, a receiver 305 may receive an indication from an interferer 315 of resources reserved by the interferer 315, and the receiver 305 may forward the resources reserved by the interferer 315 to the transmitter 310 in a resource information forwarding message. In another example, the interferer 315 may reserve the same resources as the transmitter 310 or overlapping resources with the transmitter 310 leading to interference at the receiver 305. In this example, the receiver 305 may transmit an indication of the conflict to the transmitter 310. Although inter-UE coordination messages may help to coordinate sidelink communications in a wireless communications system, it may be challenging to manage the timing of these messages.

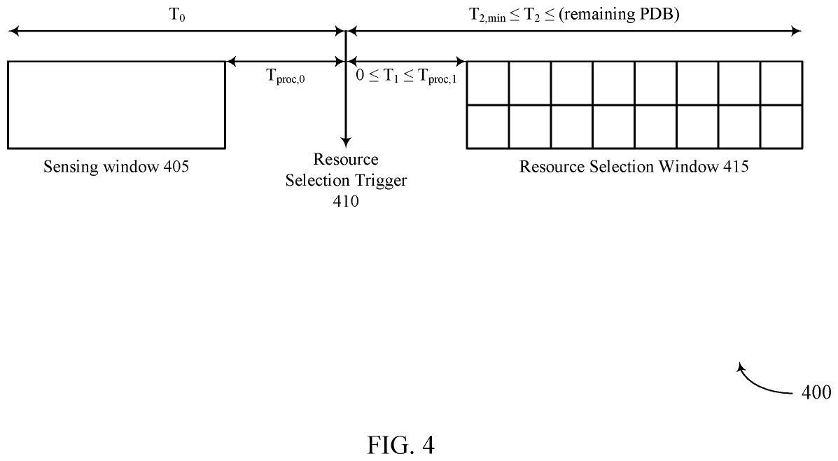

FIG. 4 illustrates an example of a packet processing timeline 400 for inter-UE coordination in accordance with aspects of the present disclosure. A UE 115 may perform sensing in a sensing window 405 to, for example, monitor for SCI from other UEs 115 reserving resources for sidelink communications. The UE 115 may then process the SCI in a configured processing time T_{proc,0}. The duration of the sensing window 405 and the duration of T_{proc,0} may make up a time T₀. After performing sensing and processing the received SCI, the UE 115 may be triggered to select resources on which to transmit an inter-UE coordination message (e.g., based on a resource selection trigger 410). The resource selection trigger 410 may be received at a lower layer at the UE 115 from an upper layer at the UE 115. The resource selection window 415 in which to select the resources for the inter-UE coordination message may be determined by times T₁ and T₂.

The time T₁ may refer to a time for processing the inter-UE coordination message and may take as long as a configured processing time T_{proc,1}. The UE 115 may select sidelink resources in the resource selection window 415 on which to transmit the inter-UE coordination message. The resource selection window 415 may be after the time T₁. The time T₂ may refer to a time for selecting resources for the inter-UE coordination message with a lower bound of T_{2,min} and an upper bound of a remaining delay budget (e.g., a packet delay budget (PDB)). The lower bound T_{2,min} may refer to a minimum time for selecting resources for a sidelink message. Thus, the candidate resources for the inter-UE coordination message may be selected in a time window [n+T₁, n+T₂], where n is the time at which resource selection is triggered. Given an initial resource selection threshold (e.g., an RSRP threshold), the UE 115 may select a set of candidate resources for the inter-UE coordination message. For instance, the UE 115 may select the set of candidate resources to include unreserved resources and resources reserved with SCIs for which a measurement (e.g., RSRP measurement) is below a resource selection threshold. The resources available in the set (e.g., a size of the set of candidate resources) may be at least a configured percentage (e.g., X %) of available resources in the window. The initial resource selection threshold is iteratively relaxed (e.g., increased) until a point when the configured percentage of available resources is selected (e.g., X % of resources are available). From this selected set of candidate resources, the transmission resources may be chosen randomly or based on a predetermined algorithm.

In some aspects, the transmission of inter-UE coordination messages (e.g., resource information forwarding messages) may be time-critical. For instance, in a case where dedicated resources may not be available for inter-UE coordination messages (e.g., resource information forwarding messages), and a UE 115 selects resources for an inter-UE coordination message as in FIG. 4, it may be appropriate to manage the timing for transmission of the inter-UE coordination message. Having a large T₂ value may make the transmission of the inter-UE coordination message more reliable (e.g., as a resource with low collision probability may be found or selected), but, in many cases, a large T₂ value may make the information carried in the inter-UE coordination message out of date or stale. Wireless communications system 100 may support efficient techniques for managing timing for inter-UE coordination to prevent or minimize interference or collisions between sidelink transmissions.

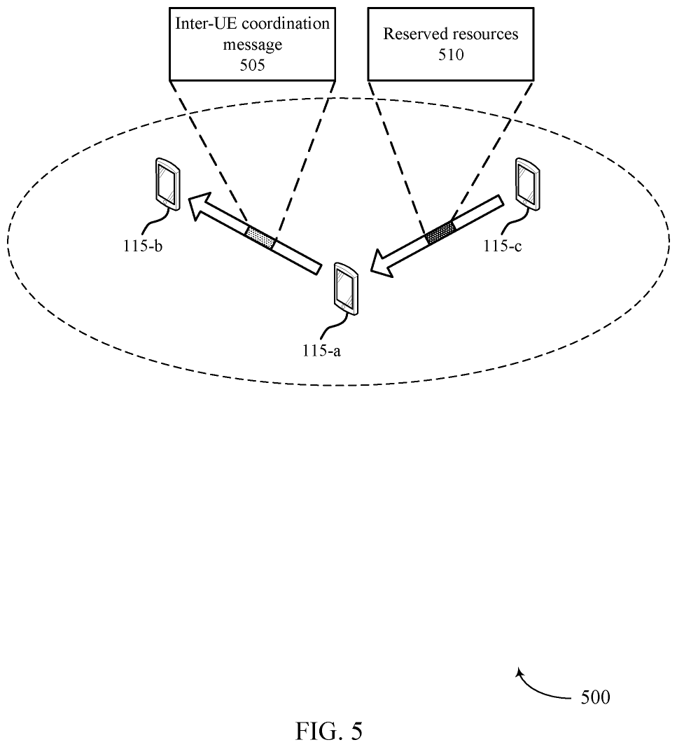

FIG. 5 illustrates an example of a wireless communications system 500 that supports timing management for inter-UE coordination in accordance with aspects of the present disclosure. The wireless communications system 500 includes a UE 115-a, a UE 115-b, and a UE 115-c, which may be examples of UEs 115 described with reference to FIGS. 1-4. The wireless communications system 500 may implement aspects of the wireless communications system 100. For example, the wireless communications system 500 may support efficient techniques for managing timing for inter-UE coordination to prevent or minimize interference or collisions between sidelink transmissions.

The UE 115-a may receive an indication 510 from the UE 115-c of resources reserved by the UE 115-c, and it may be appropriate for the UE 115-a to transmit an inter-UE coordination message 505 (e.g., a resource information forwarding message) to the UE 115-b indicating the resources reserved by the UE 115-c. Alternatively, in some cases, the UE 115-a may generate the inter-UE coordination message 505 for transmission to the UE 115-b without any indication of reserved resources from the UE 115-c. In any case, once the UE 115-a determines to generate and transmit the inter-UE coordination message 505 to the UE 115-b, it may be appropriate for the UE 115-a to determine suitable timing for transmitting the inter-UE coordination message 505 to the UE 115-b to prevent or minimize interference between sidelink transmissions on sidelink resources in the wireless communications system 500.

Using the techniques described herein, the UE 115-a may determine a time window in which to select sidelink resources for the inter-UE coordination message 505 based on a minimum time configured for selecting the sidelink resources. The minimum time configured for selecting the sidelink resources for the inter-UE coordination message 505 may be different from a minimum time configured for selecting sidelink resources for other sidelink messages. For instance, an upper layer at the UE 115-a may indicate to a lower layer at the UE 115-a (e.g., a PHY layer) a different set of timing parameters for selecting sidelink resources for the inter-UE coordination message 505 (e.g., different from timing parameters for selecting sidelink resources for other sidelink messages). Accordingly, the time window in which to select the sidelink resources for the inter-UE coordination message 505 may be adapted to allow the UE 115-b to receive the inter-UE coordination message 505 early enough to prevent interference and collisions but not too early such that the inter-UE coordination message 505 interferes or collides with a sidelink transmission.

In one aspect, the upper layer at the UE 115-a may set a different value for T_{2,min} for the inter-UE coordination message 505, such that T_{2,min}=T_{2,min}^{IUC} for inter-UE coordination messages. T_{2,min}^{IUC} may correspond to a minimum time for selecting sidelink resources for the inter-UE coordination message 505. In some examples, for inter-UE coordination messages, the UE 115-a may select sidelink resources from the pool [n+T₁, n+T_{2,min}^{IUC}] (e.g., a resource pool or pool or resources). In other examples, for inter-UE coordination messages, the UE 115-a may select sidelink resources from the pool [n+T₁, n+T₂]. In such examples T_{2,min}^{IUC}≤T₂≤T_{PDB}, where T_{PDB} is a PDB for inter-UE coordination messages. In some cases, T_{PDB} may be the same as a traffic PDB indicated by an application layer quality of service (QoS) requirement. For instance, T_{PDB} may be based on a QoS requirement at the application layer (e.g., where different QoS requirements are associated with different T_{PDB} values). In some cases, T_{PDB} may be a maximum PDB of an inter-UE coordination message indicated to the PHY layer from the upper layer.

In some cases, T_{PDB} may be determined by the resource information being shared (e.g., the contents of or the information in the inter-UE coordination message 505). For example, in one or more sets of resources being signaled in the inter-UE coordination message 505 (e.g., including a set of resources reserved by the UE 115-c), an earliest reservation or set of resources may be at a time or slot t₀. The UE 115-a transmitting the inter-UE coordination message 505 may determine that a minimum time T_{proc}^{Rx} is appropriate for a receiver (e.g., the UE 115-b) to decode and react to the reservation information in the inter-UE coordination message 505. Thus, the UE 115-a may select a value for T_{PDB} or a maximum time for selecting sidelink resources for the inter-UE coordination message 505 such that T_{PDB}=t₀−T_{proc}^{Rx}.

In some cases, the UE 115-a may select the sidelink resource for the inter-UE coordination message 505 (e.g., sidelink resources for inter-UE coordination messages may be selected) by iteratively increasing T₂ and keeping a resource selection threshold (e.g., RSRP threshold) fixed. In such cases, the UE 115-a may select an initial T₂⁰ based on upper layer indications of T_{2,min} and T_{PDB}. If a specified percentage of resources (e.g., X % of resources) are not available in a resource selection window based on the resource selection threshold, the UE 115-a may increase T₂ⁱ=T₂ⁱ⁻¹+tₓ until either the specified percentage of resources are available or T₂ⁱ=T_{PDB}.

In one aspect, the upper layer at the UE 115-a may indicate a set of T_{2,min}^{IUC} values to the PHY layer at the UE 115-a. In this aspect, each member T_{2,min}^{IUC,prio=i} of the set may correspond to a priority value (prio=i). For a given inter-UE coordination message, the maximum priority of all the indicated reservations or reserved sets of resources in the inter-UE coordination message may be used to determine the priority level of the message. For instance, the UE 115-a may determine a priority level of the inter-UE coordination message 505 based on a maximum priority of the indicated reservations or reserved sets of resources in the inter-UE coordination message 505. In some cases, along with the timing or timing information, the upper layer or a configuration at the UE 115-a may restrict the sidelink resources for inter-UE coordination to be from a subset of all available sidelink resources (e.g., subchannels or physical resource blocks).

Once the UE 115-a selects the sidelink resources in the time window for the inter-UE coordination message 505, the UE 115-a may transmit the inter-UE coordination message 505 on the selected sidelink resources to the UE 115-b over a sidelink.

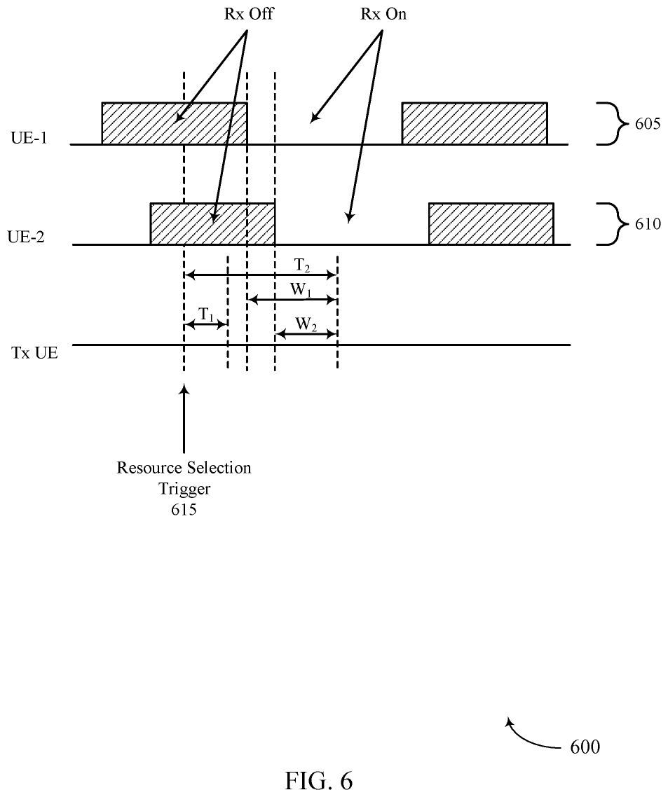

FIG. 6 illustrates an example of a timing configuration 600 for inter-UE coordination messages with discontinuous reception (DRX) in accordance with aspects of the present disclosure. A UE 115 (e.g., a transmitting UE 115) configured to transmit an inter-UE coordination message may know the DRX configuration of one or more intended receivers. For example, a transmitting UE 115 (e.g., the UE 115-a) may identify a first DRX cycle 605 of a first UE 115 (e.g., the UE 115-b or UE-1) and a second DRX cycle 610 of a second UE 115 (e.g., UE-2). Then, after a resource selection trigger 615, the transmitting UE 115 may select sidelink resources for transmitting an inter-UE coordination message to the first UE 115, the second UE 115, or both based on the first DRX cycle 605, the second DRX cycle 610, or both. For instance, each DRX cycle may include on-durations (e.g., Rx-On) and off-durations (e.g., Rx-Off), and the transmitting UE 115 may select the sidelink resources from one or more sections of a time window (e.g., a resource selection time window) that overlap with on-durations in the first DRX cycle 605 and on-durations in the second DRX cycle 610.

For the transmission of an inter-UE coordination message, the PHY layer at a transmitting UE 115 may receive DRX information from upper layers associated with one or more peer UEs 115. For example, the transmitting UE 115 may receive DRX information indicating the first DRX cycle 605 and DRX information indicating the second DRX cycle 610. Based on T_{2,min}^{IUC} and the calculation of T₂, the transmitting UE 115 (e.g., UE 115 transmitting the inter-UE coordination message) may select resources in a time window given by [n+T₁, n+T₂] based on DRX schedules of one or more intended receivers (e.g., the first DRX cycle 605 and the second DRX cycle 610). In one example, if the intended receiver is UE-1, the transmitting UE 115 may select sidelink resources for the inter-UE coordination message from the resource window W₁ (e.g., a resource window that overlaps with an on-duration of UE-1 in the time window). In another example, if both UE-1 and UE-2 are intended receivers for the inter-UE coordination message, the transmitting UE 115 may select sidelink resources for the inter-UE coordination message from the resource window W₂ (e.g., a resource window that overlaps with on-durations of UE-1 and UE-2 in the time window).

In some cases, if the transmitting UE 115 determines that the DRX cycles (e.g., on-durations) of the intended receivers or receiving UEs 115 fail to overlap for the inter-UE coordination message, the transmitting UE 115 may adjust a transmission strategy for the inter-UE coordination message. For instance, the transmitting UE 115 may select sidelink resources for the inter-UE coordination message based on determining that on-durations of a DRX cycle of one receiving UE 115 fails to overlap with on-durations of a DRX cycle of another receiving UE 115. In some examples, the transmitting UE 115 may transmit one inter-UE coordination message to a receiving UE 115 that has an earliest on-duration (e.g., an earliest on-duration that overlaps with the time window in which to select sidelink resources for the inter-UE coordination message). In some examples, the transmitting UE 115 may transmit the inter-UE coordination message more than once with or without updates to the contents based on more recent information.

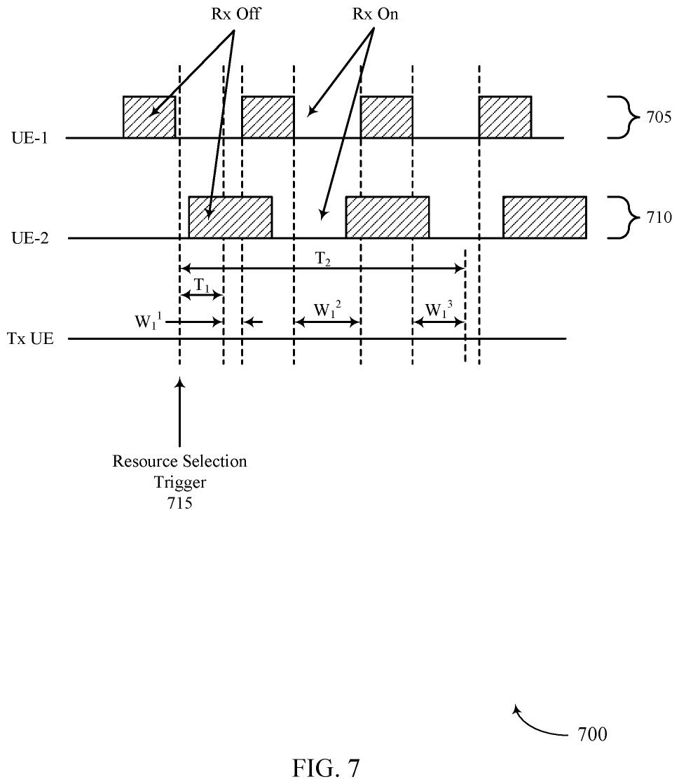

FIG. 7 illustrates an example of a timing configuration 700 for inter-UE coordination messages with DRX in accordance with aspects of the present disclosure. A UE 115 (e.g., a transmitting UE 115) configured to transmit an inter-UE coordination message may know (e.g., identify) the DRX configuration of one or more intended receivers. For example, a transmitting UE 115 (e.g., the UE 115-a) may identify a first DRX cycle 705 of a first UE 115 (e.g., the UE 115-b or UE-1) and a second DRX cycle 710 of a second UE 115 (e.g., UE-2). Then, after a resource selection trigger 715, the transmitting UE 115 may select sidelink resources for transmitting an inter-UE coordination message to the first UE 115, the second UE 115, or both based on the first DRX cycle 705, the second DRX cycle 710, or both. For instance, each DRX cycle may include on-durations (e.g., Rx-On) and off-durations (e.g., Rx-Off), and the transmitting UE 115 may select the sidelink resources from one or more sections of a time window (e.g., a resource selection time window) that overlap with on-durations in the first DRX cycle 705 or on-durations in the second DRX cycle 710. In FIG. 7, if the first UE 115 (e.g., UE-1) is the intended receiver of the inter-UE coordination message, the transmitting UE 115 may select sidelink resources for the inter-UE coordination message from the union of the windows W=[W₁¹, W₁², W₁³].

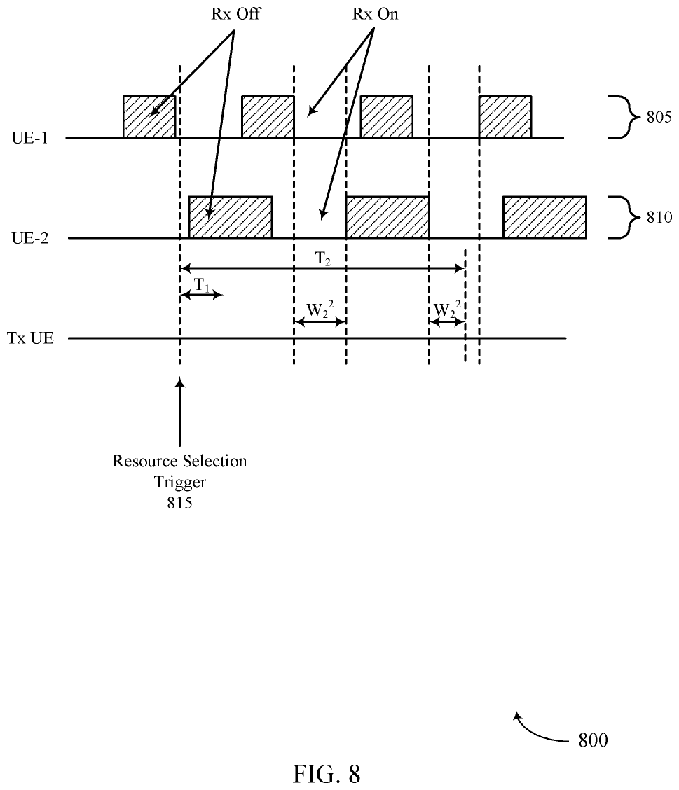

FIG. 8 illustrates an example of a timing configuration 800 for inter-UE coordination messages with DRX in accordance with aspects of the present disclosure. A UE 115 (e.g., a transmitting UE 115) configured to transmit an inter-UE coordination message may know (e.g., identify) the DRX configuration of one or more intended receivers. For example, a transmitting UE 115 (e.g., the UE 115-a) may identify a first DRX cycle 805 of a first UE 115 (e.g., the UE 115-b or UE-1) and a second DRX cycle 810 of a second UE 115 (e.g., UE-2). Then, after a resource selection trigger 815, the transmitting UE 115 may select sidelink resources for transmitting an inter-UE coordination message to the first UE 115, the second UE 115, or both based on the first DRX cycle 805, the second DRX cycle 810, or both. For instance, each DRX cycle may include on-durations (e.g., Rx-On) and off-durations (e.g., Rx-Off), and the transmitting UE 115 may select the sidelink resources from one or more sections of a time window (e.g., a resource selection time window) that overlap with on-durations in the first DRX cycle 805 or on-durations in the second DRX cycle 810. In FIG. 8, if the first UE 115 (e.g., UE-1) and the second UE 115 (e.g., UE-2) are the intended receivers of the inter-UE coordination message, the transmitting UE 115 may select sidelink resources for the inter-UE coordination message from the union of the windows W=[W₂¹, W₂²].

As described with reference to FIGS. 6-8, the transmitting UE 115 may select sidelink resources for an inter-UE coordination message from one or more sections of a resource selection time window that overlap with on-durations in DRX cycles of one or more receiving UEs 115. In some aspects, the transmitting UE 115 may determine the candidate resource set for transmission of the inter-UE coordination message by iteratively changing a resource selection threshold (e.g., RSRP threshold) until a specified percentage of resources (e.g., X % of resources) in a composite time window W are available. The composite time window W may refer to the aggregated sections of a resource selection time window that overlap with DRX cycles (e.g., on-durations) of one or more receiving UEs 115. In other aspects, the transmitting UE 115 may determine the candidate resource set for transmission of the inter-UE coordination message by adaptively increasing T₂ (T₂ⁱ→T₂ⁱ⁻¹+tₓ) and Wⁱ→Wⁱ⁻¹+Wₓ until a specified percentage of resources in Wⁱ (e.g., X % of resources) are available at a given resource selection threshold (e.g., RSRP threshold).

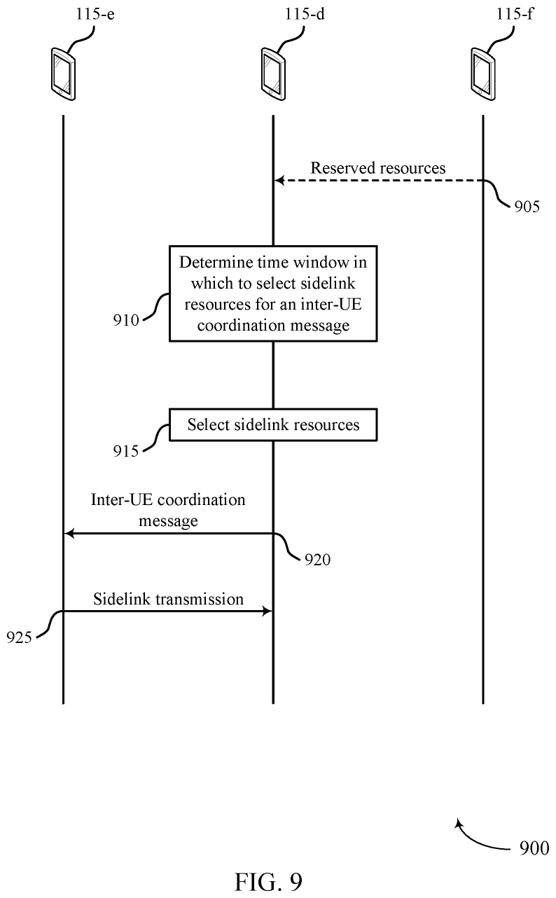

FIG. 9 illustrates an example of a process flow 900 that supports timing management for inter-UE coordination in accordance with aspects of the present disclosure. Process flow 900 includes a UE 115-d, a UE 115-e, and a UE 115-f, which may be examples of UEs 115 described with reference to FIGS. 1-8. The process flow 900 may implement aspects of the wireless communications system 100 or the wireless communications system 500. For example, the process flow 900 may support efficient techniques for managing timing for inter-UE coordination to prevent or minimize interference or collisions between sidelink transmissions.

In the following description of the process flow 900, the signaling exchanged between the UE 115-d, the UE 115-e, and the UE 115-f may be exchanged in a different order than the example order shown, or the operations performed by the UE 115-d, the UE 115-e, or the UE 115-f may be performed in different orders or at different times. Some operations may also be omitted from the process flow 900, and other operations may be added to the process flow 900.

At 905, the UE 115-d may receive, from the UE 115-f, an SCI message indicating a set of sidelink resources reserved by the UE 115-f The UE 115-d may then determine to transmit an inter-UE coordination message (e.g., a resource information forwarding message) to the UE 115-e based on receiving the indication of reserved resources at 905. Alternatively, in some cases, the UE 115-d may determine to transmit the inter-UE coordination message to the UE 115-e without receiving an indication of reserved resources. In such cases, the inter-UE coordination may include other information besides indications of resources reserved by other UEs 115.

At 910, the UE 115-d may determine a time window in which to select sidelink resources for the inter-UE coordination message based on a minimum time configured for selecting the sidelink resources for the inter-UE coordination message. At 915, the UE 115-d may then select the sidelink resources in the time window for the inter-UE coordination message. The minimum time configured for selecting the sidelink resources for the inter-UE coordination message may be different from a minimum time configured for selecting sidelink resources for other sidelink messages. That is, the UE 115-d may be configured with a first minimum time for selecting sidelink resources for inter-UE coordination messages and a second minimum time for selecting sidelink resources for other sidelink messages (e.g., data messages). In some cases, the UE 115-d may receive an indication from a base station 105 of a first configuration of the first minimum time and a second configuration of the second minimum time.

In some cases, the UE 115-d may determine that a duration of the time window in which to select sidelink resources for the inter-UE coordination message is equal to the minimum time configured for selecting the sidelink resources for the inter-UE coordination message (e.g., the duration of the time window is equal to a difference between a time T₁ and a time T_{2,min}^{IUC}). In some cases, the UE 115-d may determine that a duration of the time window in which to select sidelink resources for the inter-UE coordination message is between the minimum time configured for selecting the sidelink resources for the inter-UE coordination message and a maximum time configured for selecting the sidelink resources for the inter-UE coordination message (e.g., the duration of the time window is equal to a difference between a time T₁ and a time T₂, where T_{2,min}^{IUC}≤T₂≤T_{PDB}). The maximum time may be equal to a delay budget (e.g., PDB) for the inter-UE coordination message. The delay budget for the inter-UE coordination message may be based on a QoS requirement associated with the inter-UE coordination message, a maximum delay indicated in an upper layer configuration for the inter-UE coordination message, or contents of the inter-UE coordination message. The inter-UE coordination message may indicate one or more sets of resources reserved by one or more other UEs for sidelink communications, and the maximum delay for the inter-UE coordination message may be based on a time at which each of the one or more sets of resources is reserved.

In some cases, the UE 115-d may select an initial time window in which to select the sidelink resources for the inter-UE coordination message based on the minimum time configured for selecting the sidelink resources. The UE 115-d may then expand the initial time window until a threshold quantity of resources is selected (e.g., until the UE 115-d selects the threshold quantity of resources) or until a duration of the expanded time window is equal to a maximum time configured for selecting the sidelink resources for the inter-UE coordination message. The UE 115-d may select the sidelink resources in the initial time window or the expanded time window based on a fixed resource selection threshold (e.g., an RSRP threshold).

In some cases, the UE 115-d may identify a priority value associated with the inter-UE coordination message, and the UE 115-d may determine the minimum time configured for selecting the sidelink resources based on the identified priority value. The UE 115-d may determine a maximum priority value of one or more sets of resources reserved by other UEs 115 indicated in the inter-UE coordination message, and the UE 115-d may identify the priority value associated with the inter-UE coordination message to be equal to the determined maximum priority value.

In some cases, the UE 115-d may identify a DRX cycle of the UE 115-e, and the UE 115-d may select the sidelink resources in the time window based on the DRX cycle of the UE 115-e. For instance, the UE 115-d may select the sidelink resources from one or more sections of the time window that overlap with an on-duration or multiple on-durations of the DRX cycle of the UE 115-e. In some cases, the UE 115-d may be scheduled to transmit the inter-UE coordination message to the UE 115-e and another UE 115, and there may be no overlap between on-durations of the DRX cycles of the UE 115-e and the other UE 115. In such cases, the UE 115-d may select sidelink resources for transmitting the inter-UE coordination message to either the UE 115-e or the other UE 115 depending on which UE 115 has an on-duration overlapping with an earlier set of sidelink resources in the time window.

As an example, the UE 115-d may determine that a first on-duration (e.g., upcoming on-duration) of a first DRX cycle of the UE 115-e fails to overlap with a second on-duration (e.g., upcoming on-duration) of a second DRX cycle of another UE 115, and the UE 115-d may select the sidelink resources for transmitting the inter-UE coordination message to the UE 115-e based on the first on-duration of the UE 115-e overlapping with an earlier set of resources in the time window than the second on-duration of the other UE 115. The UE 115-d may then transmit a subsequent inter-UE coordination message to the other UE 115, where the subsequent inter-UE coordination message includes the same or different contents or information from the inter-UE coordination message transmitted to the UE 115-e.

In some cases, the UE 115-d may select the sidelink resources for the inter-UE coordination message from the one or more sections of the time window that overlap with the on-duration of the DRX cycle of the UE 115-e based on iteratively adjusting a resource selection threshold (e.g., an RSRP threshold). In some cases, the UE 115-d may select an initial time window for selecting the sidelink resources for the inter-UE coordination message based on the minimum time configured for selecting the sidelink resources, and the UE 115-d may expand the initial time window and, by extension, the one or more sections of the time window that overlap with the on-duration of the DRX cycle of the second UE until a threshold quantity of resources is selected or until a duration of the expanded time window is equal to a maximum time configured for selecting the sidelink resources. In some cases, the UE 115-d may select the sidelink resources in the initial time window or the expanded time window based on a fixed resource selection threshold (e.g., an RSRP threshold).

At 920, the UE 115-d may transmit the inter-UE coordination message to the UE 115-e on the selected sidelink resources. In some cases, the UE 115-d may select the sidelink resources for the inter-UE coordination message from a subset of available sidelink resources, and the subset of available sidelink resources may be allocated for transmitting inter-UE coordination messages. In some cases, the UE 115-d may receive, at a lower layer from an upper layer, an indication of the minimum time configured for selecting the sidelink resources for the inter-UE coordination message. At 925, the UE 115-e may transmit a sidelink transmission to the UE 115-d or another UE 115 based on the inter-UE coordination message received from the UE 115-d (e.g., avoiding the resources reserved by the UE 115-f). That is, the UE 115-e may communicate with the UE 115-d or another UE 115 based on the inter-UE coordination message received from the UE 115-d.

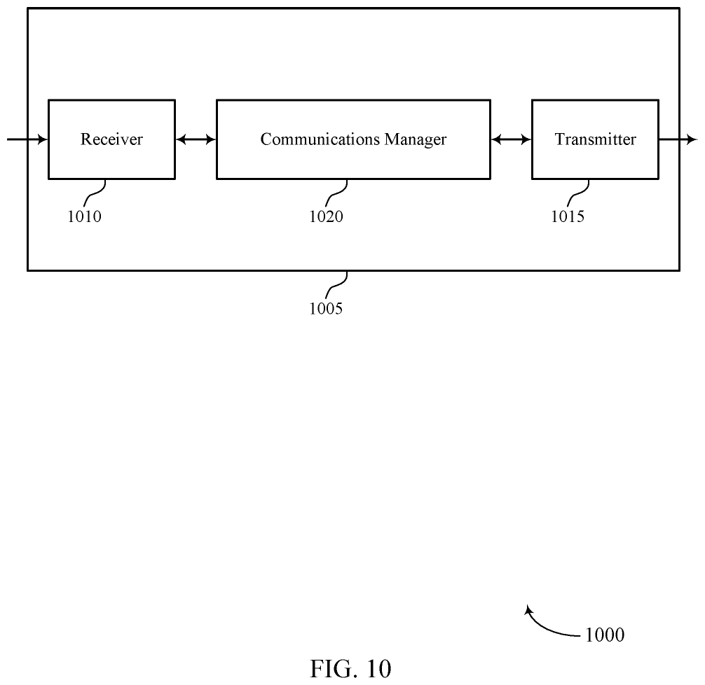

FIG. 10 shows a block diagram 1000 of a device 1005 that supports timing management for inter-UE coordination in accordance with aspects of the present disclosure. The device 1005 may be an example of aspects of a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to timing management for inter-UE coordination). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to timing management for inter-UE coordination). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of timing management for inter-UE coordination as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a first UE in accordance with examples as disclosed herein. For example, the communications manager 1020 may be configured as or otherwise support a means for determining a time window in which to select sidelink resources for an inter-UE coordination message based on a minimum time configured for selecting the sidelink resources for the inter-UE coordination message, where the minimum time configured for selecting the sidelink resources for the inter-UE coordination message is different from a minimum time configured for selecting sidelink resources for other sidelink messages. The communications manager 1020 may be configured as or otherwise support a means for selecting the sidelink resources in the time window for the inter-UE coordination message based on the determining. The communications manager 1020 may be configured as or otherwise support a means for transmitting the inter-UE coordination message on the selected sidelink resources to a second UE over a sidelink.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced processing, reduced power consumption, and more efficient utilization of communication resources. Because a first UE may determine suitable timing for transmitting an inter-UE coordination message to a second UE, the information in the inter-UE coordination message may not be out of date or stale, and the second UE may use the information to communicate effectively on sidelink resources and avoid interfering or colliding with other transmissions on the sidelink resources. Further, because the second UE may avoid interfering and colliding with other transmissions on the sidelink resources, the second UE may waste less processing time and processing power on processing sidelink messages that may fail due to interference or collisions on the sidelink resources.

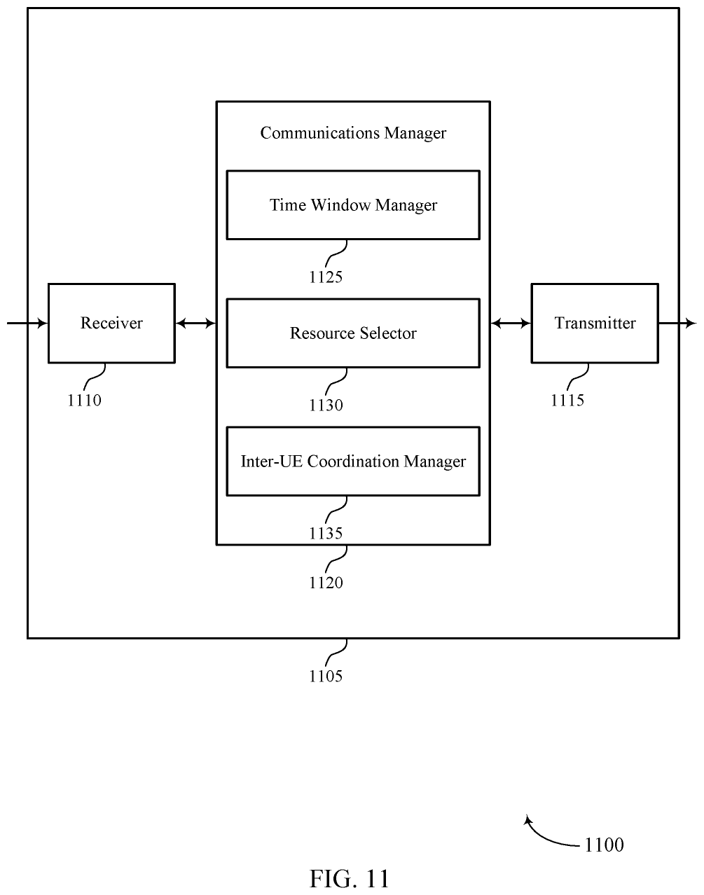

FIG. 11 shows a block diagram 1100 of a device 1105 that supports timing management for inter-UE coordination in accordance with aspects of the present disclosure. The device 1105 may be an example of aspects of a device 1005 or a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to timing management for inter-UE coordination). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to timing management for inter-UE coordination). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of timing management for inter-UE coordination as described herein. For example, the communications manager 1120 may include a time window manager 1125, a resource selector 1130, an inter-UE coordination manager 1135, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a first UE in accordance with examples as disclosed herein. The time window manager 1125 may be configured as or otherwise support a means for determining a time window in which to select sidelink resources for an inter-UE coordination message based on a minimum time configured for selecting the sidelink resources for the inter-UE coordination message, where the minimum time configured for selecting the sidelink resources for the inter-UE coordination message is different from a minimum time configured for selecting sidelink resources for other sidelink messages. The resource selector 1130 may be configured as or otherwise support a means for selecting the sidelink resources in the time window for the inter-UE coordination message based on the determining. The inter-UE coordination manager 1135 may be configured as or otherwise support a means for transmitting the inter-UE coordination message on the selected sidelink resources to a second UE over a sidelink.

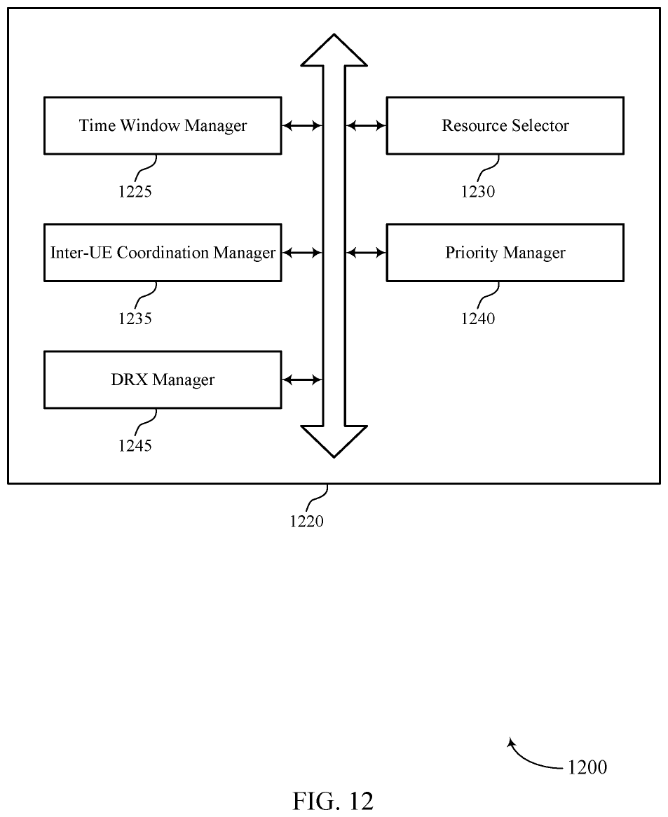

FIG. 12 shows a block diagram 1200 of a communications manager 1220 that supports timing management for inter-UE coordination in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of timing management for inter-UE coordination as described herein. For example, the communications manager 1220 may include a time window manager 1225, a resource selector 1230, an inter-UE coordination manager 1235, a priority manager 1240, a DRX manager 1245, or any combination thereof. Each of these components may communicate, directly or indirectly, with one another (e.g., via one or more buses).

The communications manager 1220 may support wireless communication at a first UE in accordance with examples as disclosed herein. The time window manager 1225 may be configured as or otherwise support a means for determining a time window in which to select sidelink resources for an inter-UE coordination message based on a minimum time configured for selecting the sidelink resources for the inter-UE coordination message, where the minimum time configured for selecting the sidelink resources for the inter-UE coordination message is different from a minimum time configured for selecting sidelink resources for other sidelink messages. The resource selector 1230 may be configured as or otherwise support a means for selecting the sidelink resources in the time window for the inter-UE coordination message based on the determining. The inter-UE coordination manager 1235 may be configured as or otherwise support a means for transmitting the inter-UE coordination message on the selected sidelink resources to a second UE over a sidelink.

In some examples, to support determining the time window, the time window manager 1225 may be configured as or otherwise support a means for determining that a duration of the time window is equal to the minimum time configured for selecting the sidelink resources for the inter-UE coordination message.

In some examples, to support determining the time window, the time window manager 1225 may be configured as or otherwise support a means for determining that a duration of the time window is between the minimum time configured for selecting the sidelink resources for the inter-UE coordination message and a maximum time configured for selecting the sidelink resources for the inter-UE coordination message, where the maximum time is equal to a delay budget for the inter-UE coordination message.

In some examples, the delay budget for the inter-UE coordination message is based on a quality of service requirement associated with the inter-UE coordination message, a maximum delay indicated in an upper-layer configuration for the inter-UE coordination message, contents of the inter-UE coordination message, or a combination thereof.

In some examples, the inter-UE coordination message indicates one or more sets of resources reserved by one or more other UEs for sidelink communications, and the maximum delay for the inter-UE coordination message is based on a time at which each of the one or more sets of resources is reserved.

In some examples, to support determining the time window, the time window manager 1225 may be configured as or otherwise support a means for selecting an initial time window in which to select the sidelink resources for the inter-UE coordination message based on the minimum time configured for selecting the sidelink resources. In some examples, to support determining the time window, the time window manager 1225 may be configured as or otherwise support a means for expanding the initial time window until a threshold quantity of resources is selected or until a duration of the expanded time window is equal to a maximum time configured for selecting the sidelink resources for the inter-UE coordination message.

In some examples, to support selecting the sidelink resources, the resource selector 1230 may be configured as or otherwise support a means for selecting the sidelink resources in the initial time window or the expanded time window based on a fixed resource selection threshold.

In some examples, the priority manager 1240 may be configured as or otherwise support a means for identifying a priority value associated with the inter-UE coordination message. In some examples, the time window manager 1225 may be configured as or otherwise support a means for determining the minimum time configured for selecting the sidelink resources based on the identified priority value.

In some examples, to support identifying the priority value associated with the inter-UE coordination message, the priority manager 1240 may be configured as or otherwise support a means for determining a maximum priority value of one or more sets of resources reserved by other UEs indicated in the inter-UE coordination message. In some examples, to support identifying the priority value associated with the inter-UE coordination message, the priority manager 1240 may be configured as or otherwise support a means for identifying the priority value associated with the inter-UE coordination message to be equal to the determined maximum priority value.

In some examples, to support selecting the sidelink resources in the time window, the DRX manager 1245 may be configured as or otherwise support a means for identifying a discontinuous reception cycle of the second UE. In some examples, to support selecting the sidelink resources in the time window, the resource selector 1230 may be configured as or otherwise support a means for selecting the sidelink resources in the time window based on the discontinuous reception cycle of the second UE.

In some examples, to support selecting the sidelink resources based on the discontinuous reception cycle of the second UE, the resource selector 1230 may be configured as or otherwise support a means for selecting the sidelink resources from one or more sections of the time window that overlap with an on-duration of the discontinuous reception cycle of the second UE.

In some examples, the on-duration of the discontinuous reception cycle of the second UE includes a first on-duration of a first discontinuous reception cycle of the second UE, and the DRX manager 1245 may be configured as or otherwise support a means for determining that the first on-duration of the first discontinuous reception cycle of the second UE fails to overlap with a second on-duration of a second discontinuous reception cycle of a third UE, where selecting the sidelink resources includes. In some examples, the on-duration of the discontinuous reception cycle of the second UE includes a first on-duration of a first discontinuous reception cycle of the second UE, and the resource selector 1230 may be configured as or otherwise support a means for selecting the sidelink resources for transmitting the inter-UE coordination message to the second UE based on the first on-duration of the second UE overlapping with an earlier set of resources in the time window than the second on-duration of the third UE.

In some examples, the inter-UE coordination manager 1235 may be configured as or otherwise support a means for transmitting a subsequent inter-UE coordination message to the third UE, the subsequent inter-UE coordination message including the same or different contents from the inter-UE coordination message transmitted to the second UE.

In some examples, to support selecting the sidelink resources, the resource selector 1230 may be configured as or otherwise support a means for selecting the sidelink resources from the one or more sections of the time window that overlap with the on-duration of the discontinuous reception cycle of the second UE based on iteratively adjusting a resource selection threshold.

In some examples, the time window manager 1225 may be configured as or otherwise support a means for selecting an initial time window for selecting the sidelink resources for the inter-UE coordination message based on the minimum time configured for selecting the sidelink resources. In some examples, the time window manager 1225 may be configured as or otherwise support a means for expanding the initial time window and the one or more sections of the time window that overlap with the on-duration of the discontinuous reception cycle of the second UE until a threshold quantity of resources is selected or until a duration of the expanded time window is equal to a maximum time configured for selecting the sidelink resources.

In some examples, to support selecting the sidelink resources, the resource selector 1230 may be configured as or otherwise support a means for selecting the sidelink resources in the initial time window or the expanded time window based on a fixed resource selection threshold.

In some examples, the sidelink resources selected for the inter-UE coordination message are selected from a subset of available sidelink resources. In some examples, the subset of available sidelink resources is allocated for transmitting inter-UE coordination messages.

In some examples, the time window manager 1225 may be configured as or otherwise support a means for receiving, at a lower layer from an upper layer, an indication of the minimum time configured for selecting the sidelink resources for the inter-UE coordination message.

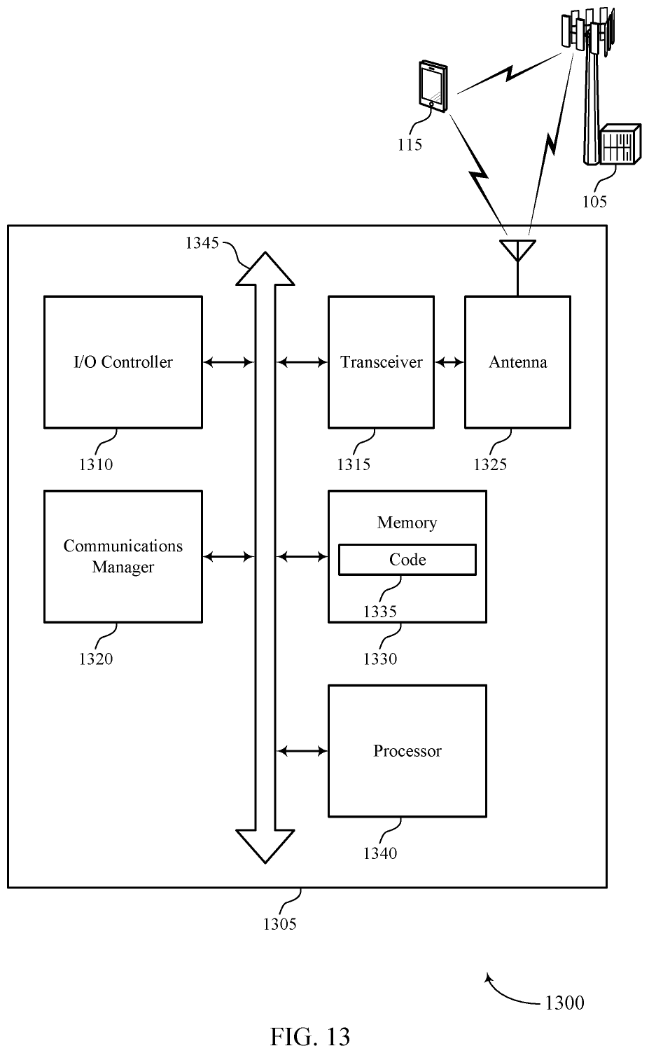

FIG. 13 shows a diagram of a system 1300 including a device 1305 that supports timing management for inter-UE coordination in accordance with aspects of the present disclosure. The device 1305 may be an example of or include the components of a device 1005, a device 1105, or a UE 115 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, an input/output (I/O) controller 1310, a transceiver 1315, an antenna 1325, a memory 1330, code 1335, and a processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally, or alternatively, the I/O controller 1310 may represent or interact with a modem, a keyboard, a mouse, a touchscreen, or a similar device. In some cases, the I/O controller 1310 may be implemented as part of a processor, such as the processor 1340. In some cases, a user may interact with the device 1305 via the I/O controller 1310 or via hardware components controlled by the I/O controller 1310.

In some cases, the device 1305 may include a single antenna 1325. However, in some other cases, the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include random access memory (RAM) and read-only memory (ROM). The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a basic I/O system (BIOS) which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting timing management for inter-UE coordination). For example, the device 1305 or a component of the device 1305 may include a processor 1340 and memory 1330 coupled to the processor 1340, the processor 1340 and memory 1330 configured to perform various functions described herein.

The communications manager 1320 may support wireless communication at a first UE in accordance with examples as disclosed herein. For example, the communications manager 1320 may be configured as or otherwise support a means for determining a time window in which to select sidelink resources for an inter-UE coordination message based on a minimum time configured for selecting the sidelink resources for the inter-UE coordination message, where the minimum time configured for selecting the sidelink resources for the inter-UE coordination message is different from a minimum time configured for selecting sidelink resources for other sidelink messages. The communications manager 1320 may be configured as or otherwise support a means for selecting the sidelink resources in the time window for the inter-UE coordination message based on the determining. The communications manager 1320 may be configured as or otherwise support a means for transmitting the inter-UE coordination message on the selected sidelink resources to a second UE over a sidelink.

By including or configuring the communications manager 1320 in accordance with examples as described herein, the device 1305 may support techniques for reduced processing, reduced power consumption, and more efficient utilization of communication resources. Because a first UE may determine suitable timing for transmitting an inter-UE coordination message to a second UE, the information in the inter-UE coordination message may not be out of date or stale, and the second UE may use the information to communicate effectively on sidelink resources and avoid interfering or colliding with other transmissions on the sidelink resources. Further, because the second UE may avoid interfering and colliding with other transmissions on the sidelink resources, the second UE may waste less processing time and processing power on processing sidelink messages that may fail due to interference or collisions on the sidelink resources.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of timing management for inter-UE coordination as described herein, or the processor 1340 and the memory 1330 may be otherwise configured to perform or support such operations.

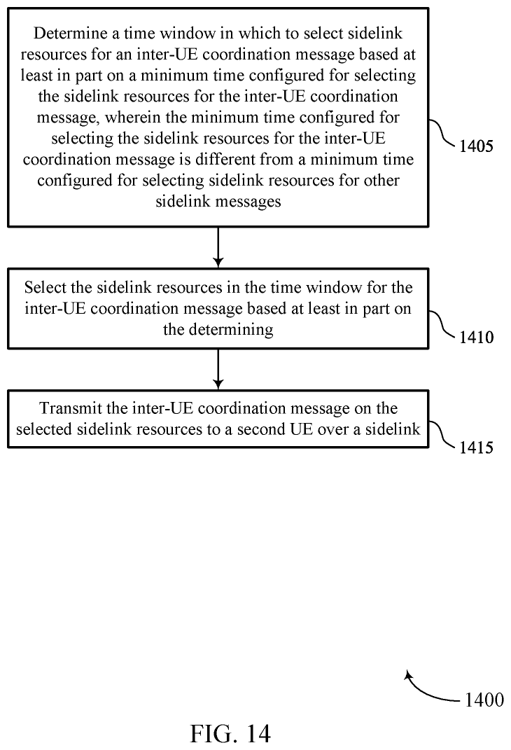

FIG. 14 shows a flowchart illustrating a method 1400 that supports timing management for inter-UE coordination in accordance with aspects of the present disclosure. The operations of the method 1400 may be implemented by a UE or its components as described herein. For example, the operations of the method 1400 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1405, the method may include determining a time window in which to select sidelink resources for an inter-UE coordination message based on a minimum time configured for selecting the sidelink resources for the inter-UE coordination message, where the minimum time configured for selecting the sidelink resources for the inter-UE coordination message is different from a minimum time configured for selecting sidelink resources for other sidelink messages. The operations of 1405 may be performed in accordance with examples as disclosed herein. In some examples, aspects of the operations of 1405 may be performed by a time window manager 1225 as described with reference to FIG. 12.

At 1410, the method may include selecting the sidelink resources in the time window for the inter-UE coordination message based on the determining. The operations of 1410 may be performed in accordance with examples as disclosed herein. In some examples, aspects of the operations of 1410 may be performed by a resource selector 1230 as described with reference to FIG. 12.

At 1415, the method may include transmitting the inter-UE coordination message on the selected sidelink resources to a second UE over a sidelink. The operations of 1415 may be performed in accordance with examples as disclosed herein. In some examples, aspects of the operations of 1415 may be performed by an inter-UE coordination manager 1235 as described with reference to FIG. 12.

The following provides an overview of aspects of the present disclosure:

Aspect 1: A method for wireless communication at a first UE, comprising: determining a time window in which to select sidelink resources for an inter-UE coordination message based at least in part on a minimum time configured for selecting the sidelink resources for the inter-UE coordination message, wherein the minimum time configured for selecting the sidelink resources for the inter-UE coordination message is different from a minimum time configured for selecting sidelink resources for other sidelink messages; selecting the sidelink resources in the time window for the inter-UE coordination message based at least in part on the determining; and transmitting the inter-UE coordination message on the selected sidelink resources to a second UE over a sidelink.

Aspect 2: The method of aspect 1, wherein determining the time window comprises: determining that a duration of the time window is equal to the minimum time configured for selecting the sidelink resources for the inter-UE coordination message.

Aspect 3: The method of any of aspects 1 through 2, wherein determining the time window comprises: determining that a duration of the time window is between the minimum time configured for selecting the sidelink resources for the inter-UE coordination message and a maximum time configured for selecting the sidelink resources for the inter-UE coordination message, wherein the maximum time is equal to a delay budget for the inter-UE coordination message.

Aspect 4: The method of aspect 3, wherein the delay budget for the inter-UE coordination message is based at least in part on a quality of service requirement associated with the inter-UE coordination message, a maximum delay indicated in an upper-layer configuration for the inter-UE coordination message, contents of the inter-UE coordination message, or a combination thereof.

Aspect 5: The method of aspect 4, wherein the inter-UE coordination message indicates one or more sets of resources reserved by one or more other UEs for sidelink communications, and the maximum delay for the inter-UE coordination message is based at least in part on a time at which each of the one or more sets of resources is reserved.

Aspect 6: The method of any of aspects 1 through 5, wherein determining the time window comprises: selecting an initial time window in which to select the sidelink resources for the inter-UE coordination message based at least in part on the minimum time configured for selecting the sidelink resources; and expanding the initial time window until a threshold quantity of resources is selected or until a duration of the expanded time window is equal to a maximum time configured for selecting the sidelink resources for the inter-UE coordination message.

Aspect 7: The method of aspect 6, wherein selecting the sidelink resources comprises: selecting the sidelink resources in the initial time window or the expanded time window based at least in part on a fixed resource selection threshold.

Aspect 8: The method of any of aspects 1 through 7, further comprising: identifying a priority value associated with the inter-UE coordination message; and determining the minimum time configured for selecting the sidelink resources based at least in part on the identified priority value.

Aspect 9: The method of aspect 8, wherein identifying the priority value associated with the inter-UE coordination message comprises: determining a maximum priority value of one or more sets of resources reserved by other UEs indicated in the inter-UE coordination message; and identifying the priority value associated with the inter-UE coordination message to be equal to the determined maximum priority value.

Aspect 10: The method of any of aspects 1 through 9, wherein selecting the sidelink resources in the time window comprises: identifying a discontinuous reception cycle of the second UE; and selecting the sidelink resources in the time window based at least in part on the discontinuous reception cycle of the second UE.

Aspect 11: The method of aspect 10, wherein selecting the sidelink resources based at least in part on the discontinuous reception cycle of the second UE comprises: selecting the sidelink resources from one or more sections of the time window that overlap with an on-duration of the discontinuous reception cycle of the second UE.

Aspect 12: The method of aspect 11, wherein the on-duration of the discontinuous reception cycle of the second UE comprises a first on-duration of a first discontinuous reception cycle of the second UE, the method further comprising: determining that the first on-duration of the first discontinuous reception cycle of the second UE fails to overlap with a second on-duration of a second discontinuous reception cycle of a third UE, wherein selecting the sidelink resources comprises: selecting the sidelink resources for transmitting the inter-UE coordination message to the second UE based at least in part on the first on-duration of the second UE overlapping with an earlier set of resources in the time window than the second on-duration of the third UE.

Aspect 13: The method of aspect 12, further comprising: transmitting a subsequent inter-UE coordination message to the third UE, the subsequent inter-UE coordination message comprising the same or different contents from the inter-UE coordination message transmitted to the second UE.

Aspect 14: The method of any of aspects 11 through 13, wherein selecting the sidelink resources comprises: selecting the sidelink resources from the one or more sections of the time window that overlap with the on-duration of the discontinuous reception cycle of the second UE based at least in part on iteratively adjusting a resource selection threshold.

Aspect 15: The method of any of aspects 11 through 14, further comprising: selecting an initial time window for selecting the sidelink resources for the inter-UE coordination message based at least in part on the minimum time configured for selecting the sidelink resources; and expanding the initial time window and the one or more sections of the time window that overlap with the on-duration of the discontinuous reception cycle of the second UE until a threshold quantity of resources is selected or until a duration of the expanded time window is equal to a maximum time configured for selecting the sidelink resources.

Aspect 16: The method of aspect 15, wherein selecting the sidelink resources comprises: selecting the sidelink resources in the initial time window or the expanded time window based at least in part on a fixed resource selection threshold.

Aspect 17: The method of any of aspects 1 through 16, wherein the sidelink resources selected for the inter-UE coordination message are selected from a subset of available sidelink resources, and the subset of available sidelink resources is allocated for transmitting inter-UE coordination messages.

Aspect 18: The method of any of aspects 1 through 17, further comprising: receiving, at a lower layer from an upper layer, an indication of the minimum time configured for selecting the sidelink resources for the inter-UE coordination message.

Aspect 19: An apparatus for wireless communication at a first UE, comprising a processor; memory coupled to the processor, the memory including instructions executable by the processor to cause the apparatus to perform a method of any of aspects 1 through 18.

Aspect 20: An apparatus for wireless communication at a first UE, comprising at least one means for performing a method of any of aspects 1 through 18.

Aspect 21: A non-transitory computer-readable medium storing code for wireless communication at a first UE, the code comprising instructions executable by a processor to perform a method of any of aspects 1 through 18.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a first user equipment (UE), comprising:
a processor; and
memory coupled to the processor, the memory comprising instructions executable by the processor to cause the apparatus to:
determine a time window in which to select sidelink resources for an inter-UE coordination message based at least in part on a minimum time configured for selecting the sidelink resources for the inter-UE coordination message, wherein the minimum time configured for selecting the sidelink resources for the inter-UE coordination message is different from a minimum time configured for selecting sidelink resources for other sidelink messages;
select the sidelink resources in the time window for the inter-UE coordination message based at least in part on the determining; and
transmit the inter-UE coordination message on the selected sidelink resources to a second UE over a sidelink.

2. The apparatus of claim 1, wherein the instructions to determine the time window are executable by the processor to cause the apparatus to:
determine that a duration of the time window is equal to the minimum time configured for selecting the sidelink resources for the inter-UE coordination message.

3. The apparatus of claim 1, wherein the instructions to determine the time window are executable by the processor to cause the apparatus to:
determine that a duration of the time window is between the minimum time configured for selecting the sidelink resources for the inter-UE coordination message and a maximum time configured for selecting the sidelink resources for the inter-UE coordination message, wherein the maximum time is equal to a delay budget for the inter-UE coordination message.

4. The apparatus of claim 3, wherein the delay budget for the inter-UE coordination message is based at least in part on a quality of service requirement associated with the inter-UE coordination message, a maximum delay indicated in an upper-layer configuration for the inter-UE coordination message, contents of the inter-UE coordination message, or a combination thereof.

5. The apparatus of claim 4, wherein the inter-UE coordination message indicates one or more sets of resources reserved by one or more other UEs for sidelink communications, and the maximum delay for the inter-UE coordination message is based at least in part on a time at which each of the one or more sets of resources is reserved.

6. The apparatus of claim 1, wherein the instructions to determine the time window are executable by the processor to cause the apparatus to:
select an initial time window in which to select the sidelink resources for the inter-UE coordination message based at least in part on the minimum time configured for selecting the sidelink resources; and
expand the initial time window until a threshold quantity of resources is selected or until a duration of the expanded time window is equal to a maximum time configured for selecting the sidelink resources for the inter-UE coordination message.

7. The apparatus of claim 6, wherein the instructions to select the sidelink resources are executable by the processor to cause the apparatus to:
select the sidelink resources in the initial time window or the expanded time window based at least in part on a fixed resource selection threshold.

8. The apparatus of claim 1, wherein the instructions are further executable by the processor to cause the apparatus to:
identify a priority value associated with the inter-UE coordination message; and
determine the minimum time configured for selecting the sidelink resources based at least in part on the identified priority value.

9. The apparatus of claim 8, wherein the instructions to identify the priority value associated with the inter-UE coordination message are executable by the processor to cause the apparatus to:
determine a maximum priority value of one or more sets of resources reserved by other UEs indicated in the inter-UE coordination message; and
identify the priority value associated with the inter-UE coordination message to be equal to the determined maximum priority value.

10. The apparatus of claim 1, wherein the instructions to select the sidelink resources in the time window are executable by the processor to cause the apparatus to:
identify a discontinuous reception cycle of the second UE; and
select the sidelink resources in the time window based at least in part on the discontinuous reception cycle of the second UE.

11. The apparatus of claim 10, wherein the instructions to select the sidelink resources based at least in part on the discontinuous reception cycle of the second UE are executable by the processor to cause the apparatus to:
select the sidelink resources from one or more sections of the time window that overlap with an on-duration of the discontinuous reception cycle of the second UE.

12. The apparatus of claim 11, wherein the on-duration of the discontinuous reception cycle of the second UE comprises a first on-duration of a first discontinuous reception cycle of the second UE, and the instructions are further executable by the processor to cause the apparatus to:
determine that the first on-duration of the first discontinuous reception cycle of the second UE fails to overlap with a second on-duration of a second discontinuous reception cycle of a third UE, wherein selecting the sidelink resources comprises:
selecting the sidelink resources for transmitting the inter-UE coordination message to the second UE based at least in part on the first on-duration of the second UE overlapping with an earlier set of resources in the time window than the second on-duration of the third UE.

13. The apparatus of claim 12, wherein the instructions are further executable by the processor to cause the apparatus to:
transmit a subsequent inter-UE coordination message to the third UE, the subsequent inter-UE coordination message comprising the same or different contents from the inter-UE coordination message transmitted to the second UE.

14. The apparatus of claim 11, wherein the instructions to select the sidelink resources are executable by the processor to cause the apparatus to:
select the sidelink resources from the one or more sections of the time window that overlap with the on-duration of the discontinuous reception cycle of the second UE based at least in part on iteratively adjusting a resource selection threshold.

15. The apparatus of claim 11, wherein the instructions are further executable by the processor to cause the apparatus to:
select an initial time window for selecting the sidelink resources for the inter-UE coordination message based at least in part on the minimum time configured for selecting the sidelink resources; and
expand the initial time window and the one or more sections of the time window that overlap with the on-duration of the discontinuous reception cycle of the second UE until a threshold quantity of resources is selected or until a duration of the expanded time window is equal to a maximum time configured for selecting the sidelink resources.

16. The apparatus of claim 15, wherein the instructions to select the sidelink resources are executable by the processor to cause the apparatus to:
select the sidelink resources in the initial time window or the expanded time window based at least in part on a fixed resource selection threshold.

17. The apparatus of claim 1, wherein:
the sidelink resources selected for the inter-UE coordination message are selected from a subset of available sidelink resources, and
the subset of available sidelink resources is allocated for transmitting inter-UE coordination messages.

18. The apparatus of claim 1, wherein the instructions are further executable by the processor to cause the apparatus to:
receive, at a lower layer from an upper layer, an indication of the minimum time configured for selecting the sidelink resources for the inter-UE coordination message.

19. A method for wireless communication at a first user equipment (UE), comprising:
determining a time window in which to select sidelink resources for an inter-UE coordination message based at least in part on a minimum time configured for selecting the sidelink resources for the inter-UE coordination message, wherein the minimum time configured for selecting the sidelink resources for the inter-UE coordination message is different from a minimum time configured for selecting sidelink resources for other sidelink messages;
selecting the sidelink resources in the time window for the inter-UE coordination message based at least in part on the determining; and
transmitting the inter-UE coordination message on the selected sidelink resources to a second UE over a sidelink.

20. The method of claim 19, wherein determining the time window comprises:
determining that a duration of the time window is equal to the minimum time configured for selecting the sidelink resources for the inter-UE coordination message.

21. The method of claim 19, wherein determining the time window comprises:
determining that a duration of the time window is between the minimum time configured for selecting the sidelink resources for the inter-UE coordination message and a maximum time configured for selecting the sidelink resources for the inter-UE coordination message, wherein the maximum time is equal to a delay budget for the inter-UE coordination message.

22. The method of claim 21, wherein the delay budget for the inter-UE coordination message is based at least in part on a quality of service requirement associated with the inter-UE coordination message, a maximum delay indicated in an upper-layer configuration for the inter-UE coordination message, contents of the inter-UE coordination message, or a combination thereof.

23. The method of claim 22, wherein the inter-UE coordination message indicates one or more sets of resources reserved by one or more other UEs for sidelink communications, and the maximum delay for the inter-UE coordination message is based at least in part on a time at which each of the one or more sets of resources is reserved.

24. The method of claim 19, wherein determining the time window comprises:
selecting an initial time window in which to select the sidelink resources for the inter-UE coordination message based at least in part on the minimum time configured for selecting the sidelink resources; and
expanding the initial time window until a threshold quantity of resources is selected or until a duration of the expanded time window is equal to a maximum time configured for selecting the sidelink resources for the inter-UE coordination message.

25. The method of claim 24, wherein selecting the sidelink resources comprises:
selecting the sidelink resources in the initial time window or the expanded time window based at least in part on a fixed resource selection threshold.

26. The method of claim 19, further comprising:
identifying a priority value associated with the inter-UE coordination message; and
determining the minimum time configured for selecting the sidelink resources based at least in part on the identified priority value.

27. The method of claim 26, wherein identifying the priority value associated with the inter-UE coordination message comprises:
determining a maximum priority value of one or more sets of resources reserved by other UEs indicated in the inter-UE coordination message; and
identifying the priority value associated with the inter-UE coordination message to be equal to the determined maximum priority value.

28. The method of claim 19, wherein selecting the sidelink resources in the time window comprises:
identifying a discontinuous reception cycle of the second UE; and
selecting the sidelink resources in the time window based at least in part on the discontinuous reception cycle of the second UE.

29. An apparatus for wireless communication at a first user equipment (UE), comprising:
means for determining a time window in which to select sidelink resources for an inter-UE coordination message based at least in part on a minimum time configured for selecting the sidelink resources for the inter-UE coordination message, wherein the minimum time configured for selecting the sidelink resources for the inter-UE coordination message is different from a minimum time configured for selecting sidelink resources for other sidelink messages;
means for selecting the sidelink resources in the time window for the inter-UE coordination message based at least in part on the determining; and
means for transmitting the inter-UE coordination message on the selected sidelink resources to a second UE over a sidelink.

30. A non-transitory computer-readable medium storing code for wireless communication at a first user equipment (UE), the code comprising instructions executable by a processor to:
determine a time window in which to select sidelink resources for an inter-UE coordination message based at least in part on a minimum time configured for selecting the sidelink resources for the inter-UE coordination message, wherein the minimum time configured for selecting the sidelink resources for the inter-UE coordination message is different from a minimum time configured for selecting sidelink resources for other sidelink messages;
select the sidelink resources in the time window for the inter-UE coordination message based at least in part on the determining; and
transmit the inter-UE coordination message on the selected sidelink resources to a second UE over a sidelink.
